(19) United States
(12) Patent Application Publication
(10) Pub. No.: US 2026/0073156 A1
(43) Pub. Date: Mar. 12, 2026

(54) METHOD AND COMPUTER DEVICE TO PROVIDE PERSONALIZED CONVERSATION BY LINKING WITH EXTERNAL SYSTEM

(71) Applicant: NAVER CORPORATION, Seongnam-si (KR)

(72) Inventors: Sang-Houn OK, Seongnam-si (KR); Hyun Sang PARK, Seongnam-si (KR)

(21) Appl. No.: 19/319,081

(22) Filed: Sep. 4, 2025

(30) Foreign Application Priority Data
Sep. 6, 2024 (KR) 10 2024 0121905

(51) Int. Cl. G06F 40/40

(52) U.S. Cl. CPC G06F 40/40

(57) ABSTRACT

A conversation providing method includes receiving external information provided in relation to a user from a third party service through linkage with an external system; storing memory information about the user based on the external information; generating an utterance of an agent for conversation with the user using the memory information; and conducting the conversation with the user by providing the utterance of the agent to the user through a conversation session between the agent and the user.

### CROSS-REFERENCE TO RELATED APPLICATION(S)

This U.S. non-provisional application claims the benefit of priority under 35 U.S.C. § 119 to Korean Patent Application No. 10-2024-0121905 filed on Sep. 6, 2024, in the Korean Intellectual Property Office (KIPO), the entire contents of which are incorporated herein by reference.

### BACKGROUND OF THE INVENTION

### Field of Invention

One or more example embodiments of the present invention in the following description relate to technology for providing an artificial intelligence (AI) agent-based conversation service to check on a user's well-being.

### Description of Related Art

The dictionary definition of artificial intelligence (AI) may be technology that implements learning ability, inference ability, perception ability, and natural language comprehension ability of humans through computer programs. This artificial intelligence has made great strides due to deep learning.

In particular, due to the development of artificial intelligence, various language models are being developed. These language models not only recognize text and understand its meaning, but also extract information from data containing a large amount of text, such as a document, classify the same, and even directly generate text.

The language models are actively utilized in various fields, such as a search service, document writing (e.g., resume writing, report writing, posting writing, etc.), free conversation on various categories, data parsing from given text (e.g., data summary, classification, etc.), provision of expert knowledge, programming, and conversion of a given sentence to a sentence in an appropriate style.

Recently, agents or AI agents that provide conversational functions are actively providing services to users in various fields, such as shopping, search, healthcare, and counseling services.

However, this agent only considers the conversation content with a user that is ongoing in a current conversation session, and is limited in considering the previous conversation content between the agent and the user. Therefore, the user needs to provide information in each different conversation session with the agent or to take an active action, such as correcting what the agent utters without considering the user's situation, which causes inconvenience to the user.

### BRIEF SUMMARY OF THE INVENTION

One or more example embodiments of the present invention may generate a conversation to check on a user's well-being based on information provided by a third party service through linkage with an external system.

One or more example embodiments may generate a user customized conversation by updating memory information on a user based on information injected from an external system as well as a direct conversation with the user.

According to at least one example embodiment, there is provided a conversation providing method of a computer device including at least one processor, the conversation providing method including receiving, by the at least one processor, external information provided in relation to a user from a third party service through linkage with an external system; storing, by the at least one processor, memory information about the user based on the external information; generating, by the at least one processor, an utterance of an agent for conversation with the user using the memory information; and conducting, by the at least one processor, the conversation with the user by providing the utterance of the agent to the user through a conversation session between the agent and the user.

According to an aspect of the present invention, the receiving of the external information may include linking with the external system through an application programming interface (API) call.

According to another aspect, the receiving of the external information may include receiving the external information by linking with another application installed on an electronic device of the user or an Internet of things (IoT) device linked to the electronic device.

According to still another aspect, the receiving of the external information may include, when information indicating the user's status or situation is registered from an administrator of an artificial intelligence (AI) agent-based conversation service provided by the computer device, receiving the registered information as the external information.

According to still another aspect, the storing of the memory information may include updating the memory information with latest information by combining existing information according to the external information and new information.

According to still another aspect, the updating of the memory information may include updating the memory information with one operation of a first operation (PASS) that maintains the existing information and does not store the new information, a second operation (APPEND) that maintains the existing information and stores the new information, a third operation (REPLACE) that deletes the existing information and stores the new information, and a fourth operation (DELETE) that deletes the existing information and does not store the new information.

According to still another aspect, the generating of the utterance of the agent may include generating the utterance of the agent using a single sentence among a plurality of sentences that constitute the memory information based on the conversation context of the conversation session.

According to still another aspect, the conversation providing method may further include updating, by the at least one processor, the memory information based on conversation of a previous conversation session of the conversation session.

According to still another aspect, the updating of the memory information may include updating the memory information with the summary content that summarizes the user's utterances during the previous conversation session.

According to still another aspect, the updating of the memory information may include, when the previous conversation session is terminated, summarizing specific utterances corresponding to a preset category among the user's utterances included in the conversation of the previous conversation session in a sentence format.

According to at least one example embodiment, there is provided a non-transitory computer-readable recording medium storing a computer program to execute the conversation providing method on the computer device.

According to at least one example embodiment, there is provided a computer device including at least one processor configured to execute computer-readable instructions on the computer device, wherein the at least one processor causes the computer device to perform a process of receiving external information provided in relation to a user from a third party service through linkage with an external system; a process of storing memory information about the user based on the external information; a process of generating an utterance of an agent for conversation with the user using the memory information; and a process of conducting the conversation with the user by providing the utterance of the agent to the user through a conversation session between the agent and the user.

According to some example embodiments, when generating a conversation to check on a user's well-being, it is possible to generate a user customized conversation by updating memory information about the user based on information provided by a third party service through linkage with an external system, and accordingly, to perform an appropriate and natural optimal conversation that is tailored to the user's recent status or situation.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram illustrating a network environment according to one embodiment;

FIG. 2 is a block diagram illustrating a computer device according to one embodiment;

FIG. 3 is a block diagram illustrating a conversation providing device according to one embodiment;

FIGS. 4 to 10 are diagrams illustrating an artificial intelligence (AI) agent-based conversation service according to at least one embodiment;

FIG. 11 is a block diagram illustrating a conversation service through linkage with an external system according to one embodiment;

FIG. 12 is a flowchart illustrating a conversation service through linkage with an external system according to one embodiment; and

FIGS. 13 to 18 are diagrams illustrating examples of a customized conversation through linkage with an external system according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by present invention.

### DETAILED DESCRIPTION OF THE INVENTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of the present invention to those skilled in the art. Accordingly, known processes, elements, and techniques, may not be described with respect to some embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

As used herein, the singular forms “a,” “an,” and “the,” are intended to include the plural forms as well, unless the context clearly indicates otherwise. As used herein, the term “and/or” includes any and all combinations of one or more of the associated listed products. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, some example embodiments of the present invention will be described with reference to the accompanying drawings.

The example embodiments relate to technology that provides an artificial intelligence (AI) agent-based conversation service to check on a user's well-being, e.g., physical, mental, social, spiritual, financial, etc.

The example embodiments described herein may provide a user customized conversation according to the user's recent status or situation with respect to the user's well-being by generating a conversation to check on the user's well-being based on information provided by a third party service through linkage with an external system.

A conversation providing device according to the example embodiments may be implemented by at least one computer device, and a conversation providing method according to the example embodiments may be performed through at least one computer device included in the conversation providing device. Here, a computer program according to an example embodiment may be installed and executed on the computer device, and the computer device may perform the conversation providing method according to the example embodiments under the control of the executed computer program. The aforementioned computer program may be stored in a computer-readable recording medium to computer-implement the conversation providing method in conjunction with the computer device.

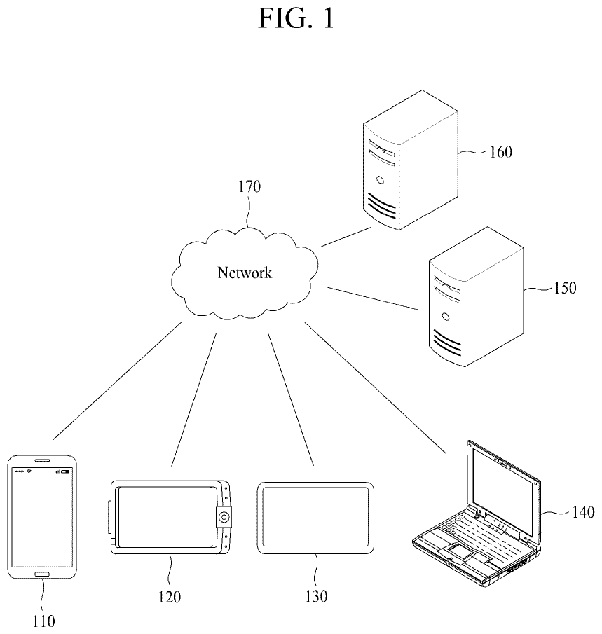

FIG. 1 illustrates an example of a network environment according to at least one example embodiment. Referring to FIG. 1, the network environment may include a plurality of electronic devices 110, 120, 130, 140, a plurality of servers 150, 160, and a network 170. FIG. 1 is provided as an example only. The number of electronic devices or the number of servers is not limited thereto. Also, the network environment of FIG. 1 describes one example among environments applicable to the example embodiments and an environment applicable to the example embodiments is not limited to the network environment of FIG. 1.

Each of the plurality of electronic devices 110, 120, 130, 140 may be a fixed terminal or a mobile terminal that is configured as a computer device. For example, the plurality of electronic devices 110, 120, 130, 140 may be a smartphone, a mobile phone, a navigation device, a computer, a laptop computer, a digital broadcasting terminal, a personal digital assistant (PDA), a portable multimedia player (PMP), a tablet personal computer (PC), and the like. For example, although FIG. 1 illustrates a shape of a smartphone as an example of the electronic device 110, the electronic device 110 used herein may refer to one of various types of physical computer devices capable of communicating with other electronic devices 120, 130, 140, and/or the servers 150, 160 over the network 170 in a wireless or wired communication manner.

The communication scheme is not limited and may include a near field wireless communication scheme between devices as well as a communication scheme using a communication network (e.g., mobile communication network, wired Internet, wireless Internet, broadcasting network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150, 160 may be configured as a computer device or a plurality of computer devices that provides instructions, a code, a file, content, a service, etc., through communication with the plurality of electronic devices 110, 120, 130, 140 over the network 170. For example, the server 150 may be a system that provides a service (e.g., AI agent-based conversation service) to the plurality of electronic devices 110, 120, 130, 140 connected over the network 170.

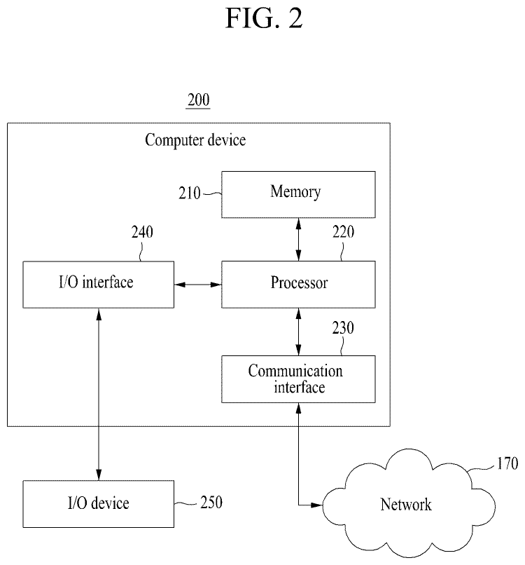

FIG. 2 is a block diagram illustrating an example of a computer device according to one example embodiment. Each of the plurality of electronic devices 110, 120, 130, 140 of FIG. 1 or each of the servers 150, 160 may be implemented by a computer device 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable recording medium. The permanent mass storage device, such as a ROM and a disk drive, may be included in the computer device 200 as a permanent storage device separate from the memory 210. Also, an OS and at least one program code may be stored in the memory 210. Such software components may be loaded to the memory 210 from another non-transitory computer-readable recording medium separate from the memory 210. The other non-transitory computer-readable recording medium may include a non-transitory computer-readable recording medium, for example, a floppy drive, a disk, a tape, a DVD/CD-ROM drive, a memory card, etc. According to other example embodiments, software components may be loaded to the memory 210 through the communication interface 230, instead of the non-transitory computer-readable recording medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided by the memory 210 or the communication interface 230 to the processor 220. For example, the processor 220 may be configured to execute received instructions in response to the program code stored in the storage device, such as the memory 210.

The communication interface 230 may provide a function for communication between the communication apparatus 200 and another apparatus, for example, the aforementioned storage devices, over the network 170. For example, the processor 220 of the computer device 200 may forward a request or an instruction created based on a program code stored in the storage device such as the memory 210, data, and a file, to other apparatuses over the network 170 under the control of the communication interface 230. Inversely, a signal, an instruction, data, a file, etc., from another apparatus may be received at the computer device 200 through the communication interface 230 of the computer device 200 over the network 170. For example, a signal, an instruction, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device of the I/O device 250 may include a microphone, a keyboard, a mouse, etc., and an output device of the I/O device 250 may include a display, a speaker, etc. As another example, the I/O interface 240 may be a device for interfacing with an apparatus in which an input function and an output function are integrated into a single function, such as a touchscreen. The I/O device 250 may be configured as a single apparatus integrated with the computer device 200.

Also, according to other example embodiments, the computer device 200 may include greater or less number of components than those shown in FIG. 2. For example, the computer device 200 may include at least a portion of the I/O device 250, or may further include other components, for example, a transceiver, a database, etc.

Hereinafter, example embodiments of a method and an apparatus for providing a personalized conversation through linkage with an external system are described.

An AI agent-based conversation service refers to a service in which an AI agent checks on a user's well-being through natural conversation using a phone or a messenger.

The AI agent-based conversation service provides a “remember conversation” function that may summarize the conversation content of a previous session when the conversation with the user is terminated and store the same as memory information about the user, and may generate a conversation based on the memory information about the user in a subsequent session.

The AI agent-based conversation service may generate a conversation based on memory information about the user, but is in a structure in which the AI agent may not store memory information about the user unless the user directly mentions a specific topic, that is, the user's status or situation, i.e., with respect to the user's well-being, in the conversation with the AI agent.

In the example embodiment, although the user does not mention the user's status or situation in the conversation with the AI agent, the memory information required for “remember conversation” may be updated with information on a system. In addition to a direct conversation with the user through the AI agent, memory information about the user may be artificially injected from a linkable system.

The computer device 200 according to the example embodiment may provide a client with an AI agent-based conversation service through a connection to a dedicated application installed on the client or a website/mobile site related to the computer device 200. The computer device 200 may be configured with a computer-implemented conversation providing device. For example, the conversation providing device may be implemented in the form of an independently operating program, or may be configured in an in-app form of a specific application to be operable on the specific application.

The processor 220 of the computer device 200 may be implemented as a component for performing the following conversation providing method. Depending on example embodiments, the components of the processor 220 may be optionally included in or excluded from the processor 220. Also, depending on example embodiments, the components of the processor 220 may be separated or merged for functional representations of the processor 220.

The processor 220 and the components of the processor 220 may control the computer device 200 to perform operations included in the following conversation providing method. For example, the processor 220 and the components of the processor 220 may be implemented to execute instructions according to a code of at least one program and a code of an operating system (OS) included in the memory 210.

Here, the components of the processor 220 may be representations of different functions performed by the processor 220 according to an instruction provided by a program code stored in the computer device 200.

The processor 220 may read necessary instructions from the memory 210 to which instructions related to control of the computer device 200 are loaded. In this case, the read instruction may include an instruction for controlling the processor 220 to execute operations described below.

The operations included in the conversation providing method described below may be performed in order different from the illustrated order, and some of the operations may be omitted or an additional process may be further included.

Operations included in the conversation providing method may be performed by the server 150, and depending on example embodiments, at least some of the operations may be performed by the electronic device 110.

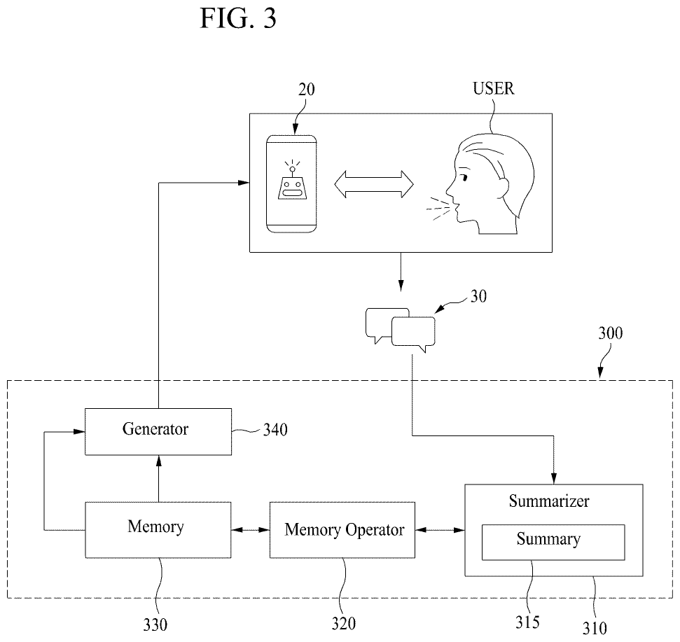

FIG. 3 is a block diagram illustrating an example of a conversation providing device according to at least one example embodiment. A conversation providing device 300 may be implemented by the computer device 200 of FIG. 2.

Referring to FIG. 3, an agent may be included as one function of various types of electronic devices 20, or may be included as one function of a website, an application, or software that provides various services for enabling a conversation between a user and the agent, such as a conversation service, a care service, or a counseling service.

The format of a conversation 30 conducted between the user and the agent may be diverse. For example, the conversation 30 may be in the form of a voice call or chat. For convenience of explanation, the conversation format is not distinguished between voice and chat. Also, regardless of the conversation format, a conversation generated from the user may be expressed as a user utterance, and a conversation generated from the agent may be expressed as an agent utterance. The agent that conducts a conversation with the user may also be a “bot” or a “chatbot.”

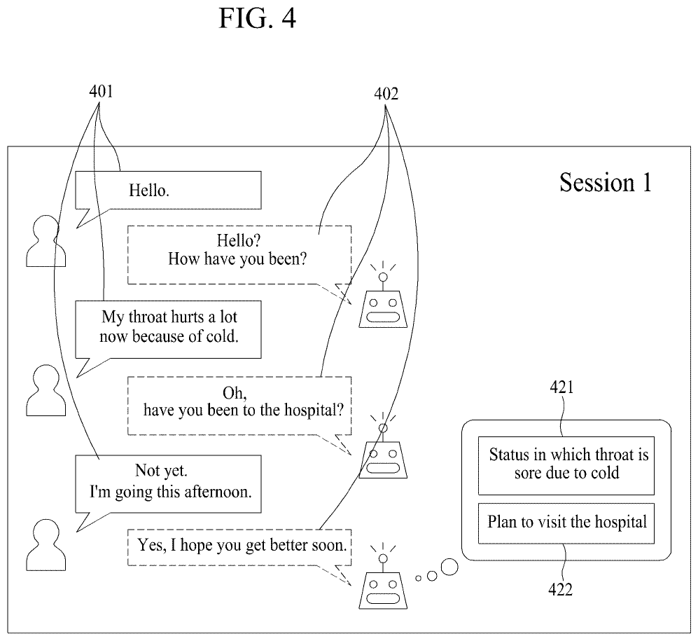

The conversation providing device 300 according to an example embodiment refers to a conversation system based on memory management that may be used when a conversation between the user and the agent is conducted multiple times at time intervals, that is, in long-term conversation. As shown in FIGS. 4 to 6, when a plurality of conversation sessions (e.g., Session 1, Session 2, Session 3) are formed between the user and the agent, a method capable of composing a conversation of a current conversation session using the conversation content of a previous conversation session is provided.

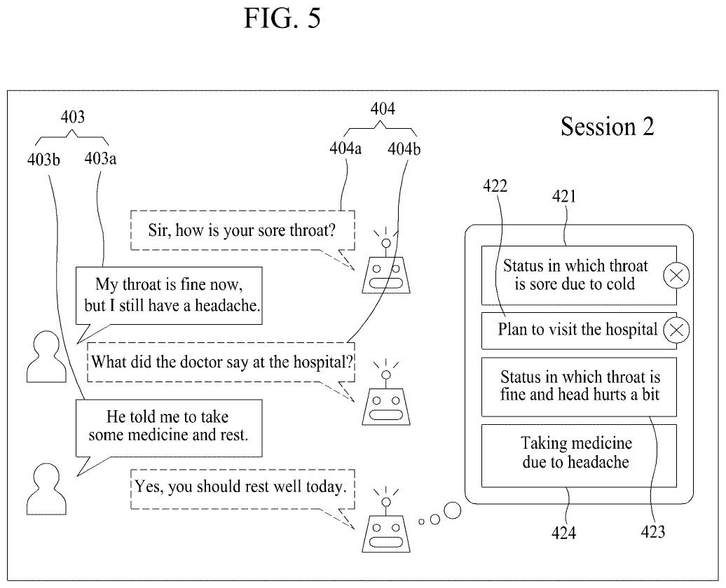

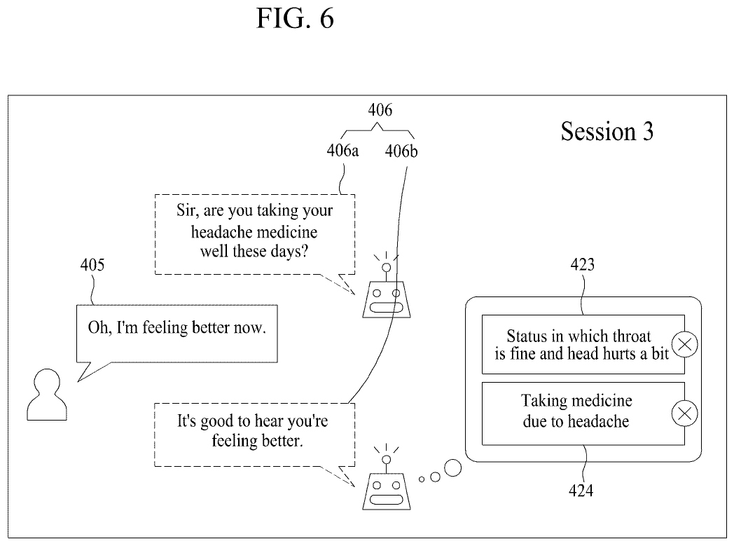

The conversation providing device 300 according to an example embodiment may perform a series of processes of receiving the conversation 30 conducted between the user and the agent and, storing information relating to the conversation content in a memory 330. Herein, information relating to the previous conversation content is stored in the memory 330. Herein, information relating to the previous conversation content stored in the memory 330 may be expressed as “user memory information.” For example, it is assumed that a first conversation session (Session 1, FIG. 4), a second conversation session (Session 2, FIG. 5), and a third conversation session (Session 3, FIG. 6) are conversation sessions having occurred sequentially from the first conversation session.

When the second conversation session is in progress, user memory information 421 and 422 based on conversations 401 and 402 between the user and the agent in the first conversation session that took place in the past may be used for an utterance 404 of the agent in the second conversation session. Further, when a conversation session corresponding to the third conversation session is in progress, memory information (421, 422, 423, 424) based on a conversation (401, 402, 403, 404) between the user and the agent corresponding to at least one of the first and second conversation sessions may be used for an utterance 406 of the agent in the third conversation session.

In the first conversation session, the content related to at least a portion of the user's utterances 401 may be stored in the memory 330 as the user memory information 421, 422. Also, the conversation providing device 300 may generate the agent's utterances 404 in the second conversation session formed between the user and the agent after the first conversation session, using the user memory information 421, 422 stored in the memory 330.

When the first conversation session is terminated, the conversation providing device 300 may store the content related to at least a portion of the conversation of the first conversation session in a sentence format in the memory 330. When the second conversation session proceeds between the user and the agent after the first conversation session, the conversation providing device 300 may generate an utterance of the agent related to one of sentences corresponding to the user memory information.

For example, the agent may generate an utterance, “Sir, how is your sore throat?” 404a, which checks the user's status or situation for user memory information “Status in which throat is sore due to cold” 421 stored in a previous conversation session or a past conversation session.

As another example, the agent may generate an utterance 404b, “What did the doctor say at the hospital?” which checks whether the user has been to the hospital in response to the user memory information 422 corresponding to “Plan to visit the hospital.”

Likewise, when the second conversation session is terminated, the conversation providing device 300 may store information relating to at least a portion of the conversation content conducted in the second conversation session as the user memory information 423, 424 in the memory 330. The user memory information 423, 424 stored in the memory 330 may be utilized in the third conversation session that proceeds after the second conversation session.

As described above, the conversation providing device 300 according to an example embodiment may manage and use the conversation content between the user and the agent in a plurality of conversation sessions, thereby enabling continuous monitoring and management on the user's various statuses (e.g., health and sleep) or situations (e.g., housing situation and employment situation) and enabling a more natural and appropriate conversation with the user.

The conversation providing device 300 according to an example embodiment may update the memory 330 such that the user's latest information on the same topic or category may be maintained. That is, user memory information stored based on the past conversation session may be updated based on the conversation of the current conversation session.

For example, in the first conversation session, the content or sentence (although the term “sentence” is used below for clarity of description, it does not necessarily need to be in the sentence format.) “Status in which throat is sore due to cold” is stored as the user memory information 421. Here, when the user's throat condition is analyzed to have improved from the progressed conversation in the second conversation session, the user may no longer have a sore throat, so the sentence “Status in which throat is sore due to cold” 421 may be deleted, and the memory 330 may be updated accordingly.

As a similar example, the content “Plan to visit the hospital” is stored as the user memory information 422. Here, when a conversation 403b in the second conversation session is analyzed that the user has visited the hospital, the content “Plan to visit the hospital” has no need to be stored as the user memory information 422, so this sentence may be deleted.

As described above, the conversation providing device 300 according to an example embodiment may store, in the memory 330, memorable information related to the user in a conversation as user memory information, or may delete unnecessary information during a conversation session between the user and the agent. The conversation providing device 300 may conduct a natural conversation based on the user's latest situation or status by generating the agent's utterance based on user memory information in a subsequent conversation session.

To this end, referring to FIG. 3, the conversation providing device 300 according to an example embodiment may include a summarizer 310, a memory operator 320, the memory 330, and a generator 340.

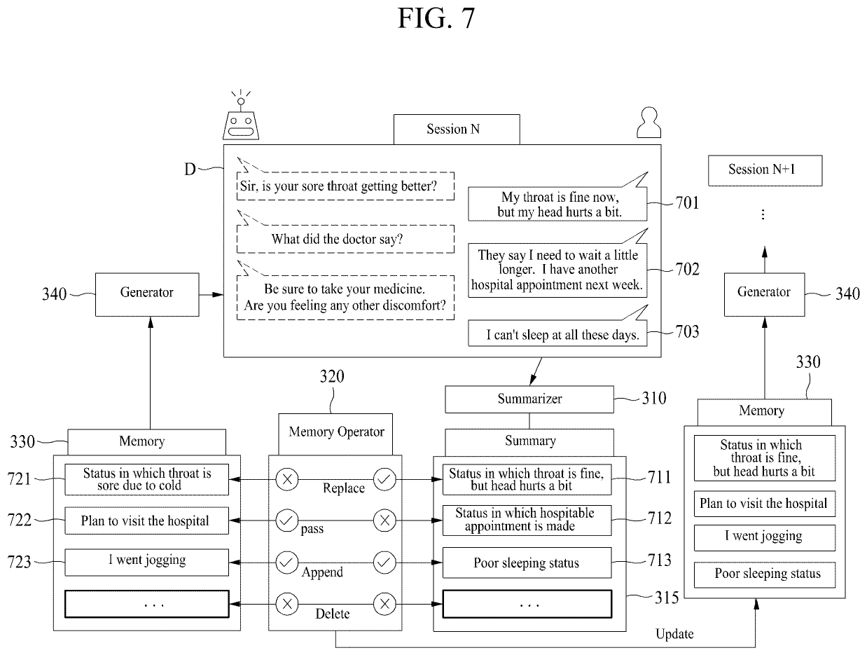

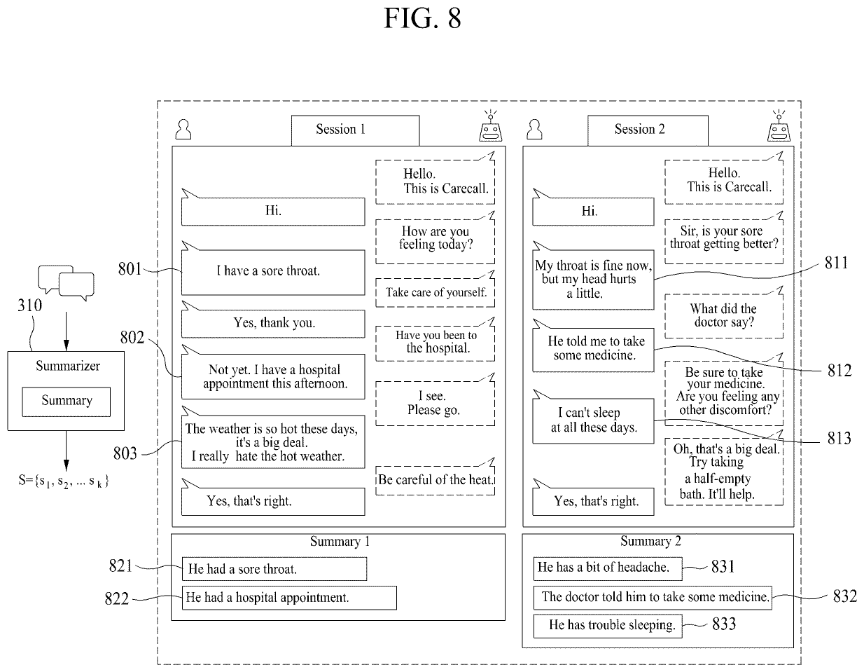

Referring to FIGS. 7 and 8, the summarizer 310 may receive the conversation content (D) of a conversation session between the agent and the user, and may generate a summary 315. A conversation of an N^{th} conversation session may be transmitted to the summarizer 310 and processed after the N^{th} conversation session is terminated. An entity that transmits the conversation to the summarizer 310 may be a service server that provides a conversation service, and is not limited to a specific entity.

The conversation, that is, dialogue D, containing the agent's utterance and the user's utterance may be input to the summarizer 310, and the summarizer 310 may generate the summary 315 based on the conversation (D).

In more detail, the summarizer 310 may summarize memorable information related to the user in the conversation content in the natural language sentence format.

The summarizer 310 may be configured as a language model trained to summarize memorable information related to the user in the conversation (D) in the natural language sentence format. For example, if a conversation is input using a language model tuned from a pretrained language model trained on a variety of information with a learning dataset that includes a conversation session and key information memorable in the conversation session, the summary content (e.g., summary sentence (although the term “summary sentence” is used below for clarity of explanation, it does not necessarily need to be in the form of the summary sentence)) may be generated. Desirably, the language model may be trained to generate the summary sentence using a newline as delimiter.

In detail, the summary model that summarizes memorable user information relating to the conversation record (D) as various natural language sentences S={s₁, s₂, . . . , sₖ} may learn parameters to minimize a given loss function for a gold summary sentence.

The summarizer 310 may be trained to generate a summary sentence only for a preset category or topic. For example, the preset category may be a category for user's various statuses or situations. For example, the preset category may be related to health, sleep, exercise, meals, and employment.

In this case, based on the conversation content related to a health category in the conversation (D), such as “My throat is fine now, but my head hurts a bit” 701, the summarizer 310 may generate summary information “Status in which throat is fine, but head hurts a bit” 711.

Also, based on the conversation content “They say I need to wait a little longer. I have another hospital appointment next week” 702 in the conversation (D), the summarizer 310 may generate summary information “Status in which hospitable appointment is made” 712.

Based on the conversation content related to the sleep category, “I can't sleep at all these days” 703 in the conversation (D), the summarizer 310 may generate summary information “Poor sleeping status” 713.

The summarizer 310 is trained to generate a summary sentence only for the content corresponding to a preset category among the user's utterances included in a conversation of a conversation session, so it may not generate a summary sentence for the content corresponding to a category different from the preset category among the user's utterances. For example, referring to FIG. 8, the summarizer 310 may generate summary sentences 821, 822, 831, 832, 833 for user utterances 801, 802, 811, 812, 813 related to health, sleep, exercise, meals, or employment corresponding to a preset category in a conversation of a conversation session (Session 1 or Session 2). The summarizer 310 may not generate a summary sentence for categories other than the preset category, for example, a conversation in the category of weather (e.g., “The weather is so hot these days, it's a big deal. I really hate the hot weather.” 803).

When a conversation is received, the summarizer 310 may generate summary sentences corresponding to user utterances and agent utterances that constitute a conversation for a preset category using a summary model. In detail, the summary model may be a language model trained to receive conversation and category information (e.g., “health” and “sleep”) as input and to generate summary information related to a corresponding category from the conversation content. Therefore, a summary sentence summarized by the summarizer 310 may be present by matching information regarding the category to which the summary sentence belongs. A summary sentence may be stored for each preset category in the memory 330. The summarizer 310 may categorize sentences before summarizing them, and as a result, may generate summary sentences only for sentences classified into the preset category. Therefore, the summarizer 310 may not generate a summary sentence for sentences that are not required to be summarized, thereby saving data resources.

Then, the memory operator 320 may control the operation of the memory 330 such that user memory information (or user information) stored in the memory 330 may maintain the latest information about the user.

The memory 330 may be present inside or outside (e.g., external server, cloud server, or cloud storage) of the conversation providing device 300. Referring to FIG. 7, the memory operator 320 may specify the operation for the memory 330 using summary sentences (or summary information 711, 712, 713) summarized by the summarizer 310 and user memory information (in detail, summary sentences 721, 722, and 723 constituting user memory information) stored in the memory 330.

As shown in FIG. 7, user memory information stored in the memory 330 may be configured according to the conversation content of previous conversation sessions formed between the user and the agent before an N^{th} conversation session is formed. The user memory information stored in the memory 330 may be configured with the summary sentences 721, 722, and 723 acquired by summarizing, by the summarizer 310, at least a portion of the conversation of previous conversation sessions. The user memory information may include the content related to the user's status or situation.

The memory 330 may be updated according to an operation specified by the memory operator 320. The memory 330 may i) store at least a portion of the summary information in the memory 330, or may ii) delete at least a portion of the stored user memory information, depending on the specified operation.

The memory operator 320 may control an operation corresponding to one of different operations for the memory 330 with respect to a pair of a summary sentence summarized from a conversation of a conversation session and a summary sentence included in user memory information stored in the memory 330 to be performed. If an operation for a summary sentence from a conversation of the N^{th} conversation session is performed, the user memory information stored in the memory 330 may be updated to reflect the conversation content of the N^{th} conversation session.

Different operations for the memory 330 defined herein with respect to a summary sentence (m) included in user memory information stored in the memory 330 and a summary sentence(s) for a new conversation session are described.

A first operation may represent an operation (PASS) that maintains to store summary sentence m in the memory 330 and does not store summary sentence s in the memory 330. The first operation may be a case in which two sentences include the same or similar content, or the content of summary sentence s is included in the content of summary sentence m. The first operation may be performed when memory update is not required.

For example, as shown in FIG. 7, for the summary sentence “Plan to visit the hospital” 722 corresponding to user memory information stored in the memory 330 and a summary sentence of a current conversation session, “Status in which hospital appointment is made” 712, the memory operator 320 may allow the user memory information stored in the memory 330 to be maintained as is.

The second operation may represent an operation (APPEND) that maintains to store summary sentence m in the memory 330 and stores summary sentence s in the memory 330 (shown as two separate components in FIG. 7, but both refer to the same memory 330). The second operation may correspond to a case in which the content of summary sentence m and the content of summary sentence s are unrelated or provide additional information.

For example, referring to FIG. 7, since there is no relevance between the summary sentence “I went jogging” 723 corresponding to the user memory information stored in the memory 330 and a summary sentence of the current conversation session, “Poor sleeping status” 713, the memory operator 320 may control the operation of the memory 330 such that the summary sentence of the current conversation session, “Poor sleeping status” 713, is newly added to the memory 330.

The third operation may represent an operation (REPLACE) that deletes summary sentence m from the memory 330 and stores summary sentence s in the memory 330. That is, summary sentence m of the memory 330 may be replaced with summary sentence s. The third operation corresponds to a case in which two sentences have mismatching or contradictory content, and the memory operator 320 may delete the conventional information stored in the memory 330 to maintain the user memory information with the user's latest information.

For example, as shown in FIG. 7, for the summary sentence “Status in which throat is sore due to cold” 721 corresponding to the user memory information stored in the memory 330 and the summary sentence of the conversation session, “Status in which throat is fine and head hurts a bit” 711, the user status has changed to a status in which the throat no longer hurts and the head hurts based on the conversation content in the N^{th} conversation session. Therefore, the memory operator 320 may control the operation of the memory 330 such that not “Status in which throat is sore due to cold” 721 but “Status in which throat is fine and head hurts a bit” 711 may be stored in the memory 330.

The fourth operation may represent an operation (DELETE) that deletes summary sentence m from the memory 330 and does not store summary sentence s in the memory 330. The fourth operation may correspond to a case in which the content of sentences no longer reflects the user's status or situation.

For example, when the summary sentence “Took cold medicine” as user memory information and the summary sentence “Cold got better” in the N^{th} conversation are present, the user's cold has been cured and does not need cold medicine. In this case, the memory 330 does not need to memorize information about the user in relation to cold.

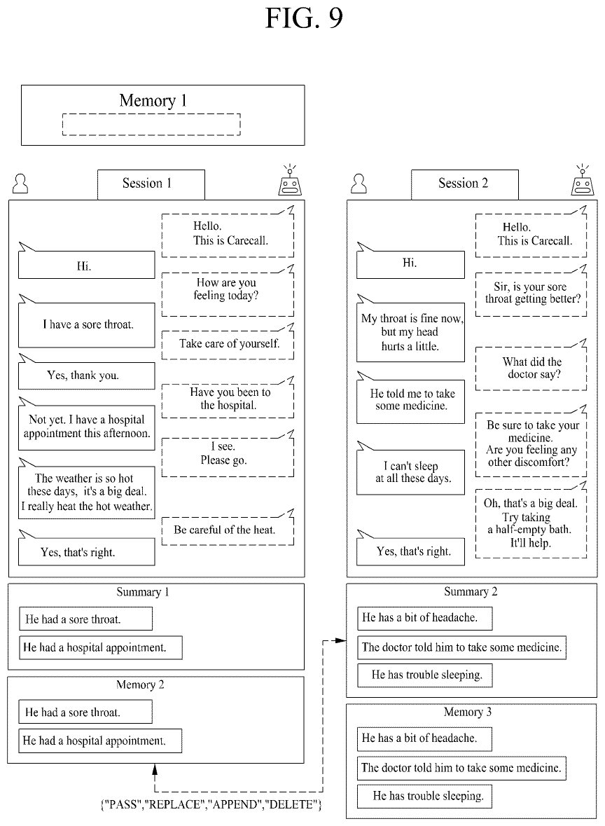

Referring to FIG. 9, the memory operator 320 may specify a memory operation according to one of the first operation to the fourth operation for summary sentences summarized in a conversation session and user memory information stored in the memory 330.

When the first conversation session (Session 1) is a first or initial conversation session in relation to the user, user memory information may be absent in the memory 330 (Memory 1). In this case, the operation results of the memory operator 320 for the first conversation session (Session 1) and the user memory information may be the second operation “APPEND.” Therefore, summary sentences (Summary 1) summarized in the first conversation session (Session 1) may be stored as is in the memory 330 (Memory 2).

When the second conversation session (Session 2) is conducted after the first conversation session (Session 1), the summarizer 310 may receive the conversation of the second conversation session and may generate summary sentences (Summary 2) for the conversation of the second conversation session. The memory operator 320 may update the memory 330 using user memory information (Memory 2) stored in the memory 330 and summary sentences (Summary 2) for the second conversation session. User memory information (Memory 3) may be configured to reflect the second conversation session (Session 2) according to the specified operation of the memory 330 for the user memory information (Memory 2) and the summary sentences (Summary 2) for the conversation of the second conversation session.

According to an example embodiment, instead of comparing every user memory information and summary sentence pair, the operation of the memory 330 may be implemented to be specified only for sentences corresponding to the same category.

Summary sentences may be classified and stored in the memory 330 by corresponding category. Therefore, the memory operator 320 may specify the operation of the memory 330 only for summary sentences between the same categories.

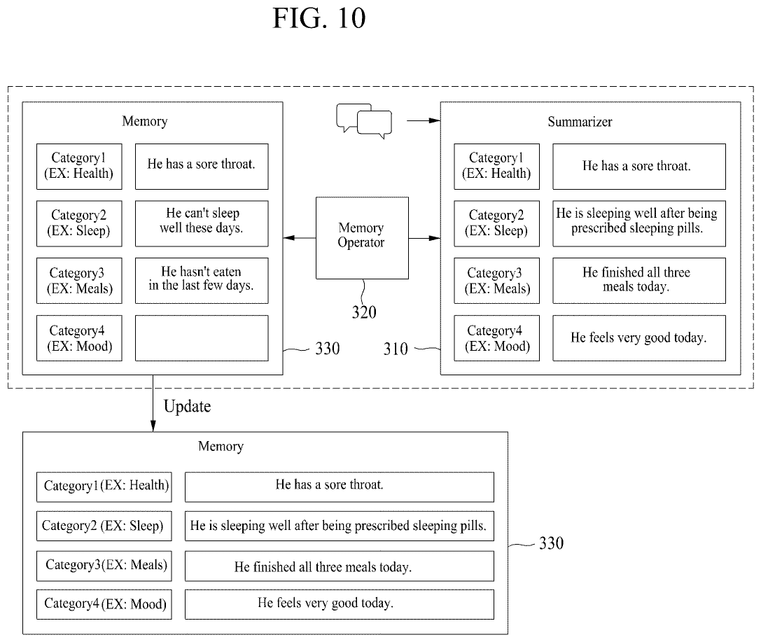

Referring to FIG. 10, when preset first to fourth categories are present, the memory operator 320 may compare sentences corresponding to the respective categories as a single pair. The memory operator 320 may specify one operation among the first to fourth operations (PASS, APPEND, REPLACE, and DELETE) for sentences input as a pair by category. As a result, user memory information stored in the memory 330 may be updated for each category.

A summary sentence may be present in the memory 330 as user memory information for each preset category. This is to maintain only information about the user's latest situation or status for each category.

As described above, the memory operator 320 may be configured using a classification model trained to predict or specify the operation of the memory 330 corresponding to one of the first to fourth operations for a single pair of sentences. A dataset for model training may be configured with a single pair of sentences corresponding to summary sentence m (or premise sentence) and summary sentence s (or hypothesis sentence) and a label indicating to which of the first to fourth operations (PASS, APPEND, REPLACE, DELETE) the single pair of sentences correspond.

The memory operator 320 may be trained based on a single pair of sentences and a single label of one of the first to fourth operations corresponding to the single pair of sentences. Labels corresponding to the first to fourth operations, respectively, may be mapped to single tokens corresponding to numbers {“0,” “1,” “2,” “3”}.

The memory operator 320 may predict or specify the operation of the memory 330 corresponding to one of the first to fourth operations for a single pair of sentences learned through the aforementioned method.

The generator 340 is configured to generate the agent's utterance using user memory information stored in the memory 330.

The generator 340 may generate the agent' utterance by referring to user memory information stored in conjunction with a user account of the user that currently conducts a conversation. The generator 340 may generate the agent's utterance using at least a portion of user memory information stored in the memory 330 and conversation history in a current session.

The generator 340 may be configured with a language model that is fine-tuned from a large language model pretrained on variety of information using “maximum likelihood estimation (MLE).”

When a plurality of summary sentences corresponding to a plurality of different categories related to the user's status or situation are present as user memory information, the generator 340 may generate the agent's utterance using a single summary sentence among the plurality of summary sentences based on the conversation context of a currently ongoing conversation session. When the conversation session between the user and the agent starts, all or a portion of the plurality of summary sentences corresponding to the user memory information stored in the memory 330 may be transmitted to the generator 340, and may be used to generate the agent's utterance in a conversation currently in progress.

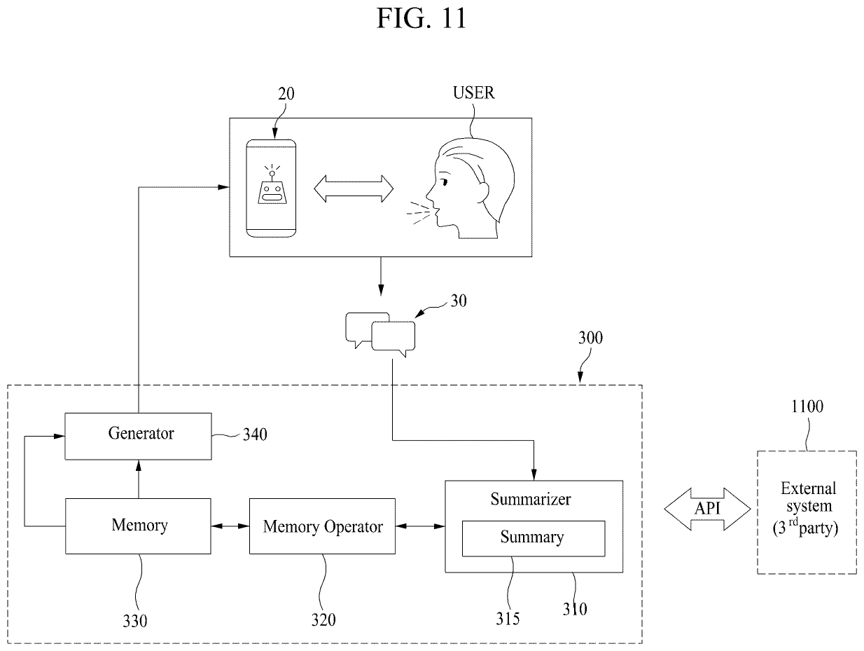

FIG. 11 is a diagram for describing a conversation service through linkage with an external system according to at least one example embodiment.

Referring to FIG. 11, the conversation providing device 300 according to an example embodiment may update user memory information with information provided by a third party service of a corresponding system through linkage with an external system 1100 in addition to the conversation 30 between the user and the agent. That is, rather than the direct conversation 30 between the user and the agent, memory information about the user may be artificially injected from the external system 1100, and used for the agent's utterance. The external system 1100 may be in the form of applications on a user's device, IoT devices, management consoles and other implementations to supply user-related information via API integration or other means.

The conversation providing device 300 may generate an utterance of checking the user's status or situation based on information provided in relation to the user from the third party service with a “Remember conversation” function of generating a conversation based on memory information about the user.

To this end, the conversation providing device 300 may include an application programming interface (API) for linking with the external system 1100, and may receive user information from the external system 1100 as information required for “Remember conversation” by linking with the external system 1100 through an API call.

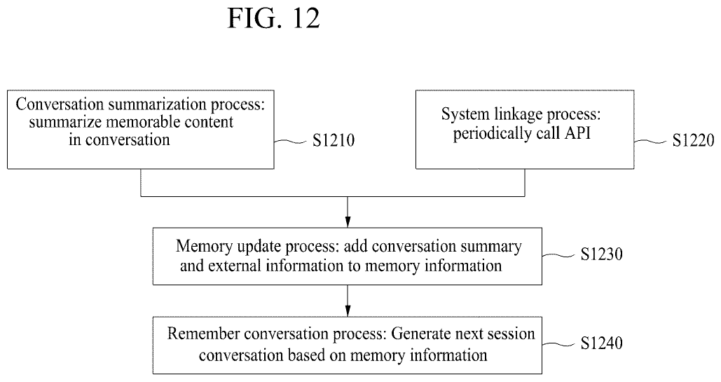

Referring to FIG. 12, the conversation providing device 300 may perform a conversation summarization process S1210. The conversation providing device 300 may receive the conversation content of a conversation session between the agent and the user, and may generate a summary. The conversation providing device 300 may summarize memorable information related to the user in the conversation content in the natural language sentence format. The details of the conversation summarization process S1210 is described above.

The conversation providing device 300 may perform a system linkage process S1220. The conversation providing device 300 may receive information provided by a third party service different from an AI agent-based conversation service, as information required for “Remember conversation” by linking with the external system 1100 through periodic API calls. The conversation providing device 300 may link with the external system 1100, such as another application installed on the electronic device 20 of the user or an Internet of Things (IoT) device linked to the electronic device 20, and may receive user information from various types of mobile apps or IoT through API.

In addition to the other application installed on the electronic device 20 of the user or the IoT device linked to the electronic device 20, the conversation providing device 300 may receive user information through an API relay server approved in advance.

In the example embodiment, information provided by the third party service to which the user has agreed to provide information may be used as user memory information.

The conversation providing device 300 may perform a memory update process S1230. In the aforementioned example embodiment, the conversation providing device 300 may update the user memory information stored in the memory 330 using a summary sentence for a conversation of a previous conversation session. The conversation providing device 300 may maintain the user's latest information by summarizing the conversation between the user and the agent, and by combining existing information and new information based on the conversation summary.

In particular, in the memory update process S1230, the conversation providing device 300 may update the user memory information with the information provided by the third party service through linkage with the external system 1100. When there is no conversation between the user and the agent, or when there is no user utterance for a preset category in the conversation between the user and the agent, the conversation summary may not be generated. Therefore, the conversation providing device 300 may receive information required for “Remember conversation” from the external system 1100, and may update the user memory information based on the received information.

The conversation providing device 300 may maintain the user memory information with the latest information by combining the existing information acquired as external information about the user and new information. The first to fourth operations for updating the user memory information stored in the memory 330 are similar to those described above. The memory operator 320 may specify a memory operation according to one of the first to fourth operations based on time with respect to summary sentences summarized in a conversation session and sentences corresponding to information on the external system 1100. That is, the memory update process S1230 may include the first operation (PASS) that maintains the existing information and does not store the new information, the second operation (APPEND) that maintains the existing information and stores the new information, the third operation (REPLACE) that deletes the existing information and stores the new information, and the fourth operation (DELETE) that deletes the existing information and does not store the new information.

The conversation providing device 300 may perform a “Remember conversation” process S1240 that provides a conversation based on memory information about the user. The conversation providing device 300 may generate an agent utterance using one of a plurality of sentences that constitute the user memory information based on the conversation context of a currently ongoing conversation session. The conversation providing device 300 may provide a personalized conversation for monitoring or checking the user's situation or status according to system information using information injected from the external system 1100, in addition to a summary sentence of a previous conversation.

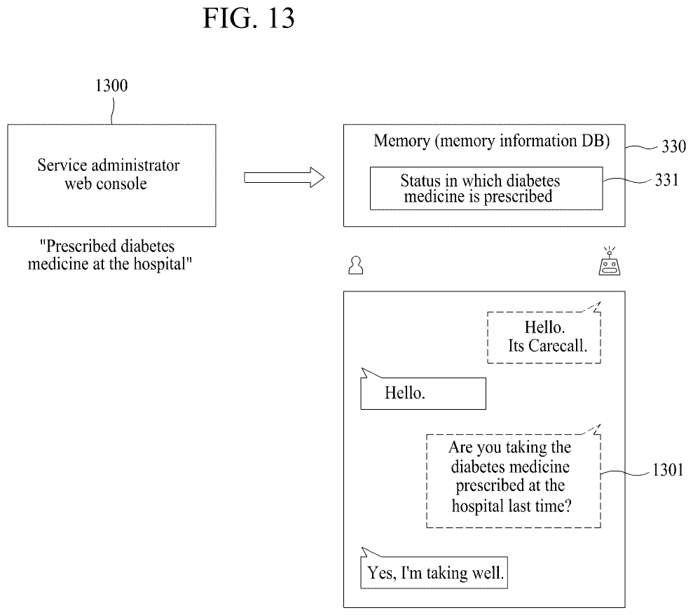

FIGS. 13 to 18 illustrate examples of a customized conversation through linkage with the external system 1100 according to at least one example embodiment.

Referring to FIG. 13, an example of the external system 1100 may be a service administrator web console 1300, and user memory information stored in the memory 330 may be updated in conjunction with the service administrator web console 1300 of an AI agent-based conversation service. When an administrator (i.e., a person that operates the service administrator web console 1300) input indicating the user's recent status or situation is registered from a service administrator through a user information management screen within the service administrator web console 1300, the user memory information of the memory 330 may be updated.

For example, if the service administrator adds a memo “Prescribed diabetes medicine at the hospital” on the user information management screen, the information is injected through periodic API calls and a sentence “Status in which diabetes medicine is prescribed” 331 may be stored in the memory 330 as the user memory information. Using the sentence “Status in which diabetes medicine is prescribed” 331, a remember conversation saying “Are you taking the diabetes medicine prescribed at the hospital last time?” 1301 may be generated.

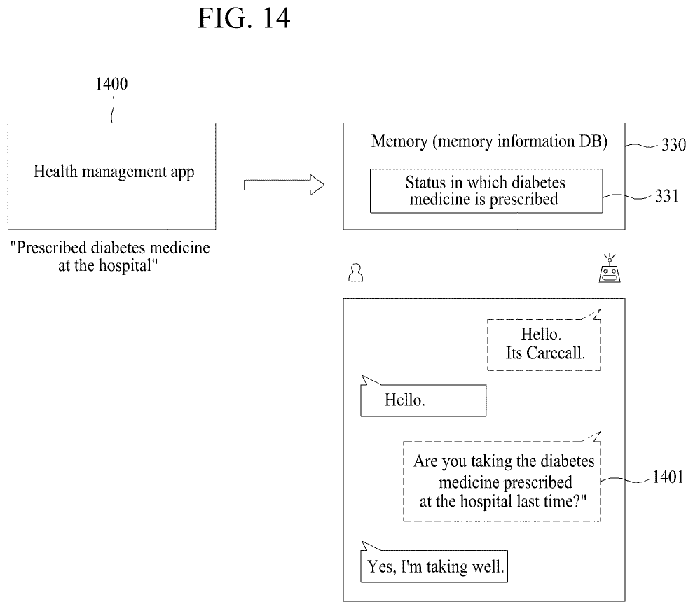

Referring to FIG. 14, another example of the external system 1100 may be a health management app 1400, and user memory information stored in the memory 330 may be updated in conjunction with the health management app 1400 installed on the electronic device 20 of the user. Health information of the user may be periodically injected from the health management app 1400, and may be used to update the user memory information of the memory 330.

For example, when information, such as “Prescribed diabetes medicine at the hospital,” or a notification to take diabetes medicine is registered to the health management app 1400 based on direct input from the user or information received from a server related to the health management app 1400, the corresponding information may be injected through periodic API calls and accordingly, the sentence “Status in which diabetes medicine is prescribed” 331 may be stored in the memory 330 as the user memory information. Using the sentence “Status in which diabetes medicine is prescribed” 331, a remember conversation saying “Are you taking the diabetes medicine prescribed at the hospital last time?” 1401 may be generated.

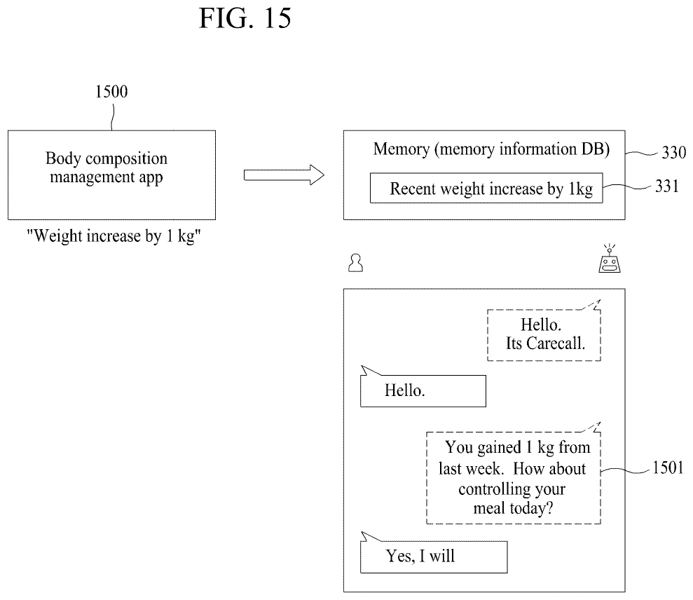

Referring to FIG. 15, still another example of the external system 1100 may be a body composition management app 1500, and user memory information stored in the memory 330 may be updated in conjunction with the body composition management app 1500 installed on the electronic device 20 of the user. Body composition information (e.g., weight, body fat, and muscle mass) of the user may be periodically injected from the body composition management app 1500, and may be used to update the user memory information of the memory 330.

For example, when the user's recent weight recorded in the body composition management app 1500 shows an increase by 1 kg compared to a previous record, the corresponding information may be injected through periodic API calls and accordingly, the sentence “Recent weight increase by 1 kg” 331 may be stored in the memory 330 as the user memory information. Using the sentence “Recent weight increase by 1 kg” 331, a remember conversation saying “You gained 1 kg from last week. How about controlling your meal today?” 1501 may be generated.

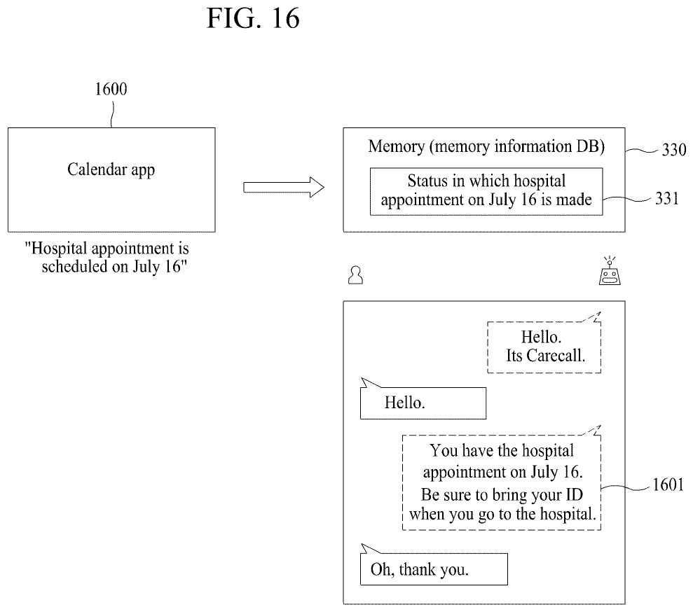

Referring to FIG. 16, still another example of the external system 1100 may be a calendar app 1600, and user memory information stored in the memory 330 may be updated in conjunction with the calendar app 1600 installed on the electronic device 20 of the user. Schedule information (e.g., health, sleep, exercise, meals, and employment) of preset categories may be injected from the calendar app 1600, and may be used to update the user memory information of the memory 330.

For example, when a hospital appointment schedule corresponding to a health category is registered on July 16 in the calendar app 1600, the corresponding information may be injected through periodic API calls and accordingly, the sentence “Status in which hospital appointment on July 16 is made” 331 may be stored in the memory 330 as the user memory information. Using the sentence “Status in which hospital appointment on July 16 is made” 331, a remember conversation saying “You have the hospital appointment on July 16. Be sure to bring your ID when you go to the hospital.” 1601 may be generated.

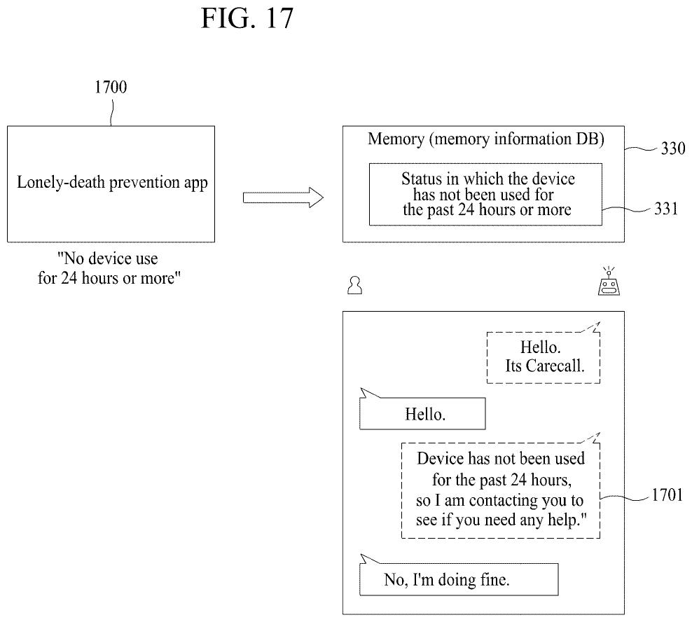

Referring to FIG. 17, still another example of the external system 1100 may be a lonely-death prevention app 1700, and user memory information stored in the memory 330 may be updated in conjunction with the lonely-death prevention app 1700 installed on the electronic device 20 of the user. The term “lonely death” as used herein refers to a circumstance in which a person dies alone. The lonely-death prevention app 1700 may analyze the usage of the electronic device 20 and may output an absence confirmation notification if there is no device use history for a preset period of time (e.g., 24 hours) or more. Here, absence confirmation notification information may be injected from the lonely-death prevention app 1700, and may be used to update the user memory information of the memory 330.

For example, when an absence confirmation notification without a device use history during a preset period of time occurs in the lonely-death prevention app 1700, the corresponding information may be injected through periodic API calls and accordingly, the sentence “Status in which the device has not been used for the past 24 hours or more” 331 may be stored in the memory 330 as the user memory information. Using the sentence “Status in which the device has not been used for the past 24 hours or more” 331, a remember conversation saying “Device has not been used for the past 24 hours, so I am contacting you to see if you need any help.” 1701 may be generated.

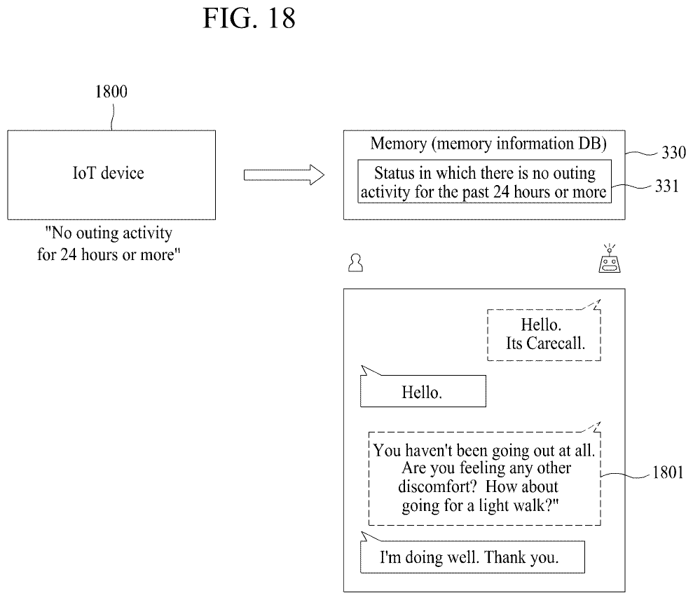

Referring to FIG. 18, still another example of the external system 1100 may be an Internet of Things (IoT) device 1800, and user memory information stored in the memory 330 may be updated in conjunction with the IoT device 1800 accessible through the electronic device 20 of the user. User activity information may be injected from the IoT device 1800, and may be used to update the user memory information of the memory 330.

For example, when the user activity analysis results through the IoT device 1800 show that the user has not been out all day, the corresponding information may be injected through periodic API calls and accordingly, the sentence saying “Status in which there is no outing activity for the past 24 hours or more” 331 may be stored in the memory 330 as the user memory information. Using the sentence saying “Status in which there is no outing activity for the past 24 hours or more” 331 a remember conversation saying “You haven't been going out at all. Are you feeling any other discomfort? How about going for a light walk?” 1801 may be generated.

The example embodiments may acquire information about a user's status or situation through linkage with an external system and may use the acquired information as user memory information for “Remember conversation” although there is no direct conversation between the user and the agent.

The conversation providing device 300 according to example embodiments may provide an AI agent-based conversation service upon request from a company contracted with an administrative agency of a country or a local government. If the company registers a user who is a service target, the conversation providing device 300 may regularly exchange a conversation with the user through an agent and may provide feedback on the conversation between the user and the agent to the company or a guardian of the user. Depending on cases, the company may provide a conversation result report to an administrative agency and the guardian, and may include a system operation that individually contacts a user if safety or health issue is suspected.

According to some example embodiments, when generating a conversation for checking on a user's well-being, memory information about the user may be updated with information provided by a third party service through linkage with an external system to generate a user customized conversation. Through this, it is possible to conduct an optimal conversation that is appropriate and natural for the user's recent status or situation.

The apparatuses described herein may be implemented using hardware components, software components, and/or the combination of the hardware components and the software components. For example, the apparatuses and the components described herein may be implemented using one or more computers or processing devices, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to the example embodiments may be recorded in non-transitory computer-readable media including program instructions executable through various computer methods. Here, the media may continuously store computer-executable programs or may transitorily store the same for execution or download. Also, the media may be various types of recording devices or storage devices in a form in which one or a plurality of hardware components are combined. Without being limited to a media directly connected to a computer system, the media may be distributed over the network. Examples of non-transitory computer-readable media include magnetic media such as hard disks, floppy disks, and magnetic tapes; optical media such as CD ROM disks and DVD; magneto-optical media such as floptical disks; and hardware devices that are specially designed to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the present invention, and all such modifications are intended to be included within the scope of the invention.

What is claimed is:

1. A conversation providing method of a computer device having at least one processor, the method comprising:
receiving external information provided in relation to a user from a third party service through linkage with an external system;
storing memory information about the user based on the external information;
generating an utterance of an agent for conversation with the user using the memory information; and
conducting the conversation with the user by providing the utterance of the agent to the user through a conversation session between the agent and the user.

2. The conversation providing method of claim 1, wherein the receiving of the external information comprises linking with the external system through an application programming interface (API) call.

3. The conversation providing method of claim 1, wherein the receiving of the external information comprises receiving the external information by linking with another application installed on an electronic device of the user or an Internet of things (IoT) device linked to the electronic device.

4. The conversation providing method of claim 1, wherein the receiving of the external information comprises, when information indicating the user's status or situation is registered from an administrator of an artificial intelligence (AI) agent-based conversation service provided by the computer device, receiving the registered information as the external information.

5. The conversation providing method of claim 1, wherein the storing of the memory information comprises updating the memory information with latest information by combining existing information according to the external information and new information.

6. The conversation providing method of claim 5, wherein the updating of the memory information comprises updating the memory information with one operation of a first operation (PASS) that maintains the existing information and does not store the new information, a second operation (APPEND) that maintains the existing information and stores the new information, a third operation (REPLACE) that deletes the existing information and stores the new information, and a fourth operation (DELETE) that deletes the existing information and does not store the new information.

7. The conversation providing method of claim 1, wherein the generating of the utterance of the agent comprises generating the utterance of the agent using a single sentence among a plurality of sentences that constitute the memory information based on the conversation context of the conversation session.

8. The conversation providing method of claim 1, further comprising:
updating, the memory information based on conversation of a previous conversation session of the conversation session.

9. The conversation providing method of claim 8, wherein the updating of the memory information comprises updating the memory information with the summary content that summarizes the user's utterances during the previous conversation session.

10. The conversation providing method of claim 8, wherein the updating of the memory information comprises, when the previous conversation session is terminated, summarizing specific utterances corresponding to a preset category among the user's utterances included in the conversation of the previous conversation session in a sentence format.

11. A non-transitory computer-readable recording medium storing a computer program to execute the conversation providing method of claim 1 on a computer device.

12. A computer device comprising:
at least one processor configured to execute computer-readable instructions stored on a memory,
wherein the at least one processor executes the processes comprising:
receiving external information provided in relation to a user from a third party service through linkage with an external system;
storing memory information about the user based on the external information;
generating an utterance of an agent for conversation with the user using the memory information; and
conducting the conversation with the user by providing the utterance of the agent to the user through a conversation session between the agent and the user.

13. The computer device of claim 12, wherein the at least one processor links with the external system through an application programming interface (API) call.

14. The computer device of claim 12, wherein the at least one processor causes receives the external information by linking with another application installed on an electronic device of the user or an Internet of things (IoT) device linked to the electronic device.

15. The computer device of claim 12, wherein the at least one processor, when information indicating the user's status or situation is registered from an administrator of an artificial intelligence (AI) agent-based conversation service provided by the computer device, receives the registered information as the external information.

16. The computer device of claim 12, wherein the at least one processor is configured to update the memory information with latest information by combining existing information according to the external information and new information.

17. The computer device of claim 16, wherein the at least one processor updates the memory information with one operation of a first operation (PASS) that maintains the existing information and does not store the new information, a second operation (APPEND) that maintains the existing information and stores the new information, a third operation (REPLACE) that deletes the existing information and stores the new information, and a fourth operation (DELETE) that deletes the existing information and does not store the new information.

18. The computer device of claim 12, wherein the at least one processor generates the utterance of the agent using a single sentence among a plurality of sentences that constitute the memory information based on the conversation context of the conversation session.

19. The computer device of claim 12, wherein the at least one processor updates the memory information based on conversation of a previous conversation session of the conversation session.

20. The computer device of claim 19, wherein the at least one processor updates the memory information with the summary content that summarizes the user's utterances during the previous conversation session.
